(19) United States
(12) Patent Application Publication
(10) Pub. No.: US 2008/0195077 A1
(43) Pub. Date: Aug. 14, 2008

(54) DISPOSABLE CONTAINER AND METHOD FOR LABELING IT

(75) Inventor: Dario Anatrini, Siena (IT)

Correspondence Address: PEARNE & GORDON LLP, 1801 EAST 9TH STREET, SUITE 1200, CLEVELAND, OH, 44114-3108, US

(73) Assignee: CO.RI.M.A. S.R.L., SIENA (IT)

(21) Appl. No.: 12/026,958

(22) Filed: Feb. 6, 2008

(30) Foreign Application Priority Data
Feb. 14, 2007 (IT) BO2007A000079

(51) Int. Cl. A61J 1/18; B65B 61/26

(52) U.S. Cl. 604/404; 53/411; 53/131.2; 206/459.5

(57) ABSTRACT

A disposable syringe having both graduated marks and a label describing the medicine contained in the syringe, obtained according to a method which involves feeding an orderly succession of syringes having the graduated marks on the body towards a labeling station; feeding an orderly succession of adhesive labels, each having a transparent portion, towards the labeling station; synchronizing each syringe with the respective label so that, subsequently, the transparent portion is placed over the graduated marks; and wrapping the respective label around the body of each syringe, first bringing a longitudinal edge of the label into contact with the syringe body then rotating the syringe about its own longitudinal axis.

### BACKGROUND OF THE INVENTION

The present invention relates to a disposable container, in particular a disposable syringe, and a method for labeling said container.

As is known, disposable syringes are filled with the relative medicine during their assembly, in a sterile environment.

The transparent body, usually cylindrical, of each syringe normally bears graduated marks, which may be stamped and/or molded on it, to allow, for example, partial use of the medicine according to the dose required for the patient.

In many cases, in addition to the graduated marks, the syringe body must also bear a label relative to the medicine it contains. In such cases, to prevent the label from covering and hiding the graduated marks on the syringe, the width of the label is less than the outer extension of the syringe body. In this way, the label can be wrapped around the syringe body except for the longitudinal band of the body bearing the graduated marks.

However, in some cases, in particular in the case of syringes with a small cross-section, the width set for the label may be so low that the most common automatic labeling machines have difficulty applying the label.

Attempts were made to solve the problem by using labels themselves bearing the graduated marks. That allows the width of the label to be substantially equal to or even slightly greater than the outer extension of the syringe body. However, the graduated marks were not very reliable because they were affected by possible errors, although small, in the application of the label.

### SUMMARY OF THE INVENTION

The aim of the present invention is to provide a container such as a disposable syringe and a method for labeling it according to which the label can easily be applied without compromising the legibility of the graduated marks on the syringe.

Accordingly, the present invention provides a disposable syringe and a method for labeling it, as described in the claims herein.

### BRIEF DESCRIPTION OF THE DRAWINGS

The present invention is now described, by way of example and without limiting the scope of application, with reference to the accompanying drawings, in which:

FIGS. 1 and 5 illustrate a disposable syringe with a respective label, made and applied in accordance with the present invention;

FIG. 2 illustrates the label of FIG. 1 laid out flat;

FIG. 3 is a perspective view with some parts cut away for clarity of a labeling machine able to implement the method in accordance with the present invention;

FIG. 4 is a perspective view with some parts cut away for clarity of a detail of FIG. 3;

FIG. 6 illustrates an alternative embodiment of the label of FIG. 2, laid out flat.

### DESCRIPTION OF THE PREFERRED EMBODIMENTS

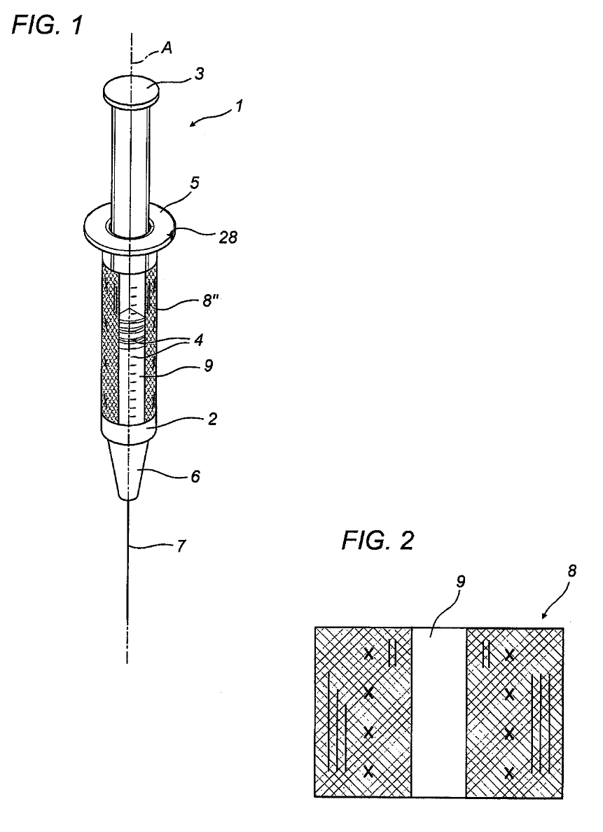

With reference to FIG. 1, the numeral 1 denotes, as a non-limiting example of a disposable container, a disposable syringe comprising a transparent tubular body 2, containing a medicine, and a plunger 3, slidably connected in a sealed fashion to the body 2 for dispensing the medicine.

The body 2 is cylindrical and has a central longitudinal axis A, along which the plunger 3 slides. At a longitudinal band, the body 2 bears, printed and/or molded, graduated marks 4, whose function is to allow partial use of the medicine, according to the dose required for the patient.

At the longitudinal end from which the plunger 3 comes out, the body 2 has a grip collar 5, whilst at the opposite longitudinal end the body 2 is closed down into a central through-hole by a housing 6 having the shape of a truncated cone, a needle 7 engaging coaxially in the housing 6.

Advantageously, wrapped around the body 2 but not necessarily through 360°, about the axis A, there is an adhesive label 8 describing the medicine. The special feature of this label is that it has a transparent portion 9 placed over the graduated marks 4. In particular, as FIG. 2 more clearly shows, the transparent portion 9 is a longitudinal band, substantially central and rectangular, of the label 8.

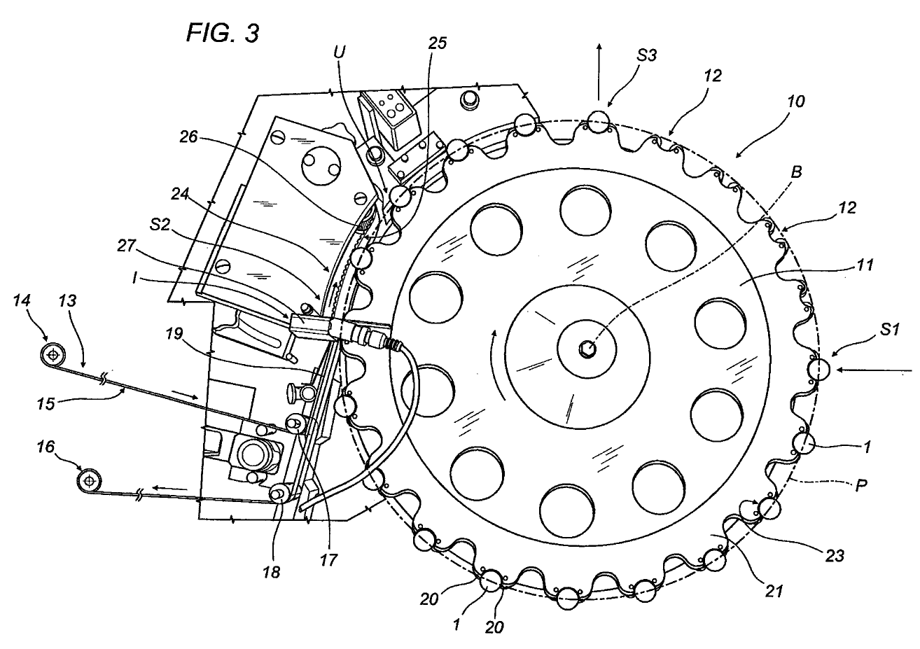

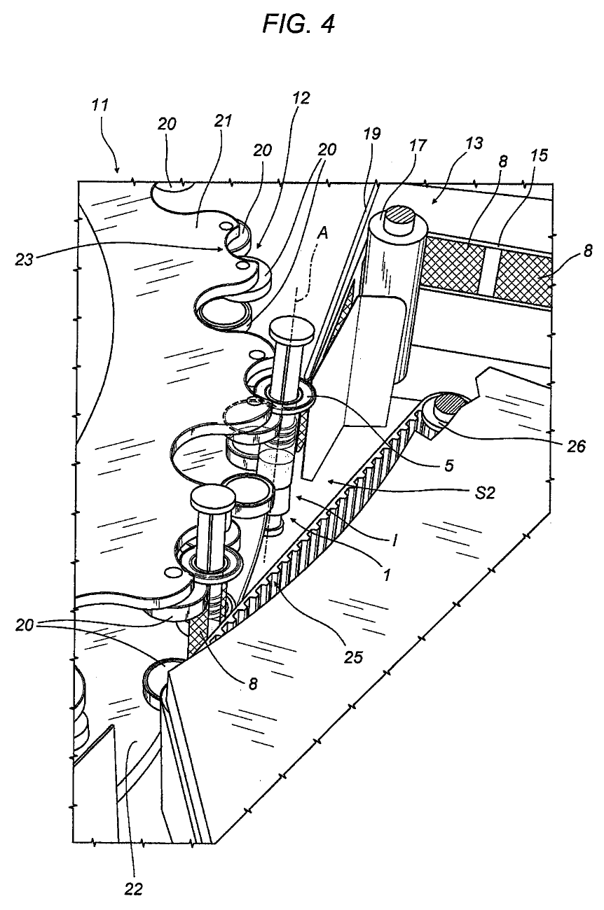

The label 8 is applied on the body 2 using the packing machine illustrated in FIGS. 3 and 4, labeled 10 as a whole.

The machine 10 comprises a carrousel 11 which rotates with a stepping motion about a vertical central axis B, clockwise in FIG. 3.

The carrousel has a plurality of outer cavities 12, evenly distributed about the axis B and each designed to convey a syringe 1, with its axis A vertical and with the needle 7 pointing downwards, on a circular path P.

The path P extends between a loading station S1, in which the syringes 1 are inserted in the respective cavities 12, and an unloading station S3, where each syringe 1, after being checked, is taken out of the respective cavity 12 and directed towards a rejection path or an acceptance path.

Inserted between the stations S1 and S3 there is a labeling station S2, where each syringe 1 receives its label 8 and along which each syringe 1 has the label 8 wrapped around it like a tube.

Converging at the station S2 infeed I there is a line 13 designed to feed an orderly succession of labels 8. The line 13 comprises a device 14 for unwinding a continuous web 15 carrying labels 8, a device 16 for recovering the web 15, after the web, having passed through the station S2 infeed I, no longer has labels 8 on it, a first web 15 return roller 17, positioned between the device 14 and the station S2, a second web 15 return roller 18, positioned between the station S2 and the device 16, and a plate 19, around which, at the station S2 infeed I, the web 15 is wound, being suddenly bent in an L shape, so that the labels 8 peel off one after another.

As FIG. 4 shows in detail, each cavity 12 supports its syringe 1 laterally with four rollers 20 having a vertical axis, coaxial with one another in pairs, so that each syringe 1 is free to rotate about its own axis A at and along the station S2. Of the four rollers 20, the two upper rollers 20 are rotatably and idly mounted on an annular plate 21, coaxial with the axis B, of the carrousel 11, whilst the other two, lower rollers 20 are rotatably and idly mounted on an annular plate 22, opposite the plate 21 in such a way that it mirrors it and also coaxial with the axis B and forming part of the carrousel 11.

The upper rollers 20 and the lower rollers 20 are mounted on the plate 21 and, respectively, on the plate 22 at the edges of respective C-shaped outer grooves 23 of the plates 21 and 22.

Relative to each cavity 12, the upper bases of the upper rollers 20 support the bottom of the collar 5 of the respective syringe 1, which is suspended in the cavity 12.

The above-mentioned infeed I is more precisely the infeed of a rolling channel 24, designed to wrap the body 2 of each syringe 1 in the respective label 8 by making the syringe 1 rotate about its own longitudinal axis A after a longitudinal edge of the label 8 has been brought into contact with the body 2 by the line 13.

On one side the channel 24 is formed by the outside of the carrousel 11 with its idle rollers 20, and on the other side by a motor-driven belt 25, opposite the outside of the carrousel 11 at a constant distance, along an arc of the carrousel.

The belt 25 is looped around at least two pulleys 26 whose axes are parallel with the axis B and rotates anti-clockwise as illustrated in FIG. 3.

At the station S2 and channel 24 infeed I, and precisely above the infeed I, there is a sensor 27 designed to detect the angular position of each syringe 1 so as to allow, as is explained below, synchronization of each syringe 1 with the respective label 8 so that the above-mentioned transparent portion 9 is placed over the graduated marks 4 on the body 2.

During machine 10 operation the syringes 1 are fed, each in its cavity 12, one after another in an orderly fashion and with a stepping motion from the station S1 towards the station S2, precisely towards the infeed I of the station S2 and the rolling channel 24. With the carrousel 11 paused, the syringe 1 at the infeed I is synchronized with the label 8 which the line 13 has, in the meantime, stopped in a predetermined position at the station S2 infeed I. Said synchronization, whose function is to ensure that subsequently the transparent portion 9 is precisely placed over the graduated marks 4, is carried out by rotating the syringe 1 at the infeed I at a constant speed about its own longitudinal axis A by means of the belt 25, using the sensor 27 to detect a marking 28 present on the syringe 1 collar 5, and calculating the time interval, from the moment of detection, for which the syringe 1 must be kept rotating, at said constant speed, for it to reach a predetermined angular position. Then, at the end of said time interval, after which the syringe 1 is in any case kept rotating, in a synchronized fashion the line 13 launches the label 8 in such a way that a longitudinal edge of the label makes contact with the syringe body 2. After the belt 25 has rotated the syringe 1 about its axis A until the label 8 is fully wrapped around the syringe, the belt 25 is stopped and the carrousel 11 moves forward one step.

Synchronization of the subsequent syringe 1 causes the syringe 1 which already received the label 8 to roll again about its axis A in the channel 24. According to alternative embodiments of this method, available to average technicians in the sector, as an alternative to the syringe 1 pause step, the syringe 1 may be kept moving and the sensor 27 can be oscillated or in any event moved over a predetermined stretch to follow syringe 1 feed, thus interacting with the latter.

Only after leaving the outfeed U of the channel 24 and the station S2, the labeled syringes 1 are taken from the carrousel 11 at the station S3.

According to an alternative embodiment, the belt 25 is continuously kept operating at a constant speed, as the carrousel 11 is gradually moved with a stepping motion, preferably so that the syringes 1 are rolled from the infeed I to the outfeed U of the channel 24 and the station S2.

According to another alternative embodiment, the sensor 27 is substituted by a camera 27. In this case, detection of the marking 28 is substituted with detection of an image of the syringe 1 coinciding with a sample image.

In this description the term graduated marks refers to a particular type of sign or indication reproduced on the particular type of disposable container represented by the syringe. However, for the purposes of this invention, the term graduated marks shall be considered non-limiting, such that it also comprises any text, logo, trade-mark or the like reproduced on the surface of a disposable container, whether it is a syringe, a vial or other type of disposable container. As already indicated, this description refers to a disposable syringe as a non-limiting example of a disposable container. In an equivalent way, the container could be a vial, an ampoule or the like, such as the cartridges for medicines used in the dental sector.

It shall be understood that equivalent to the solution in this description and claims, and therefore covered by this invention, is the application of a label which, although without any transparent portion, is wrapped around the container for an angle of less than 360°, such that it leaves uncovered the zone of the container where the graduated marks are located.

In other words, instead of using a label having a transparent portion intended to be placed over the graduated marks on the container, a label may be applied whose angular extension is less than that of the container circumference, such that the label does not cover the graduated marks and the latter are therefore legible even after application of the label. A label 8′ without a transparent window and suitable for this type of application is illustrated in FIG. 6. The label 8′, represented in the same scale as the label 8 of FIG. 2, has a reduced longitudinal extension so that it is wrapped around the syringe 1 through an angle of less than 360° and, using the method disclosed, leaves the graduated marks 4 on the syringe 1 uncovered and legible.

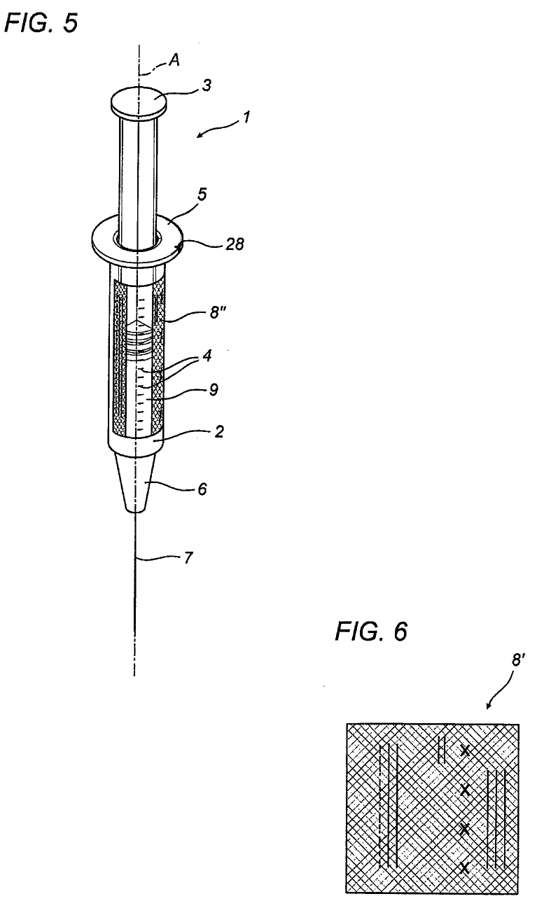

In contrast, FIG. 5 illustrates application of another alternative embodiment of a label, indicated by the reference character 8″. Although it has a transparent window 9, this label is wrapped around the syringe 1 through an angle of less than 360°, therefore leaving a predetermined stretch of the surface of the syringe 1 uncovered.

Obviously, the invention described above achieves the preset aims and it may be modified and adapted in several ways without thereby departing from the scope of the inventive concept indicated in the claims herein. Moreover, all details of the invention may be substituted by technically equivalent elements.

1) A method for labeling disposable containers, in particular disposable syringes, comprising the step of feeding an orderly succession of containers (1) having graduated marks (4) on the body (2) towards a labeling station (S2), wherein an orderly succession of adhesive labels (8) is fed towards the labeling station (S2), each label having a transparent portion (9); in the labeling station (S2) wrapping the respective label (8) around the body (2) of each container (1), first bringing a longitudinal edge of the label (8) into contact with the container (1) body (2) and then rotating the container (1) about its own longitudinal axis (A); the wrapping step being preceded by synchronization of the container (1) and the label (8) so that the transparent portion (9) is placed over the graduated marks (4).

2) The method according to claim 1, wherein synchronization is achieved by making the container (1) rotate at a constant speed about its own longitudinal axis (A), using a sensor (27) to detect a marking (28) on the container (1), calculating the time interval, from the moment of detection, for which the container (1) must be kept rotating, at said constant speed, for it to reach a predetermined angular position.

3) The method according to claim 1, wherein synchronization is achieved by making the container (1) rotate at a constant speed about its own longitudinal axis (A), using a camera (27) to detect an image of the container (1) coinciding with a sample image, calculating the time interval, from the moment of detection, for which the container (1) must be kept rotating, at said constant speed, for it to reach a predetermined angular position.

4) The method according to claim 1, wherein the transparent portion (9) is a longitudinal band of the label (8).

5) The method according to claim 4, wherein the longitudinal band is substantially rectangular.

6) The method for labeling disposable containers according to claim 1, wherein the step of wrapping the respective label (8′) around the body (2) of each container (1) is carried out in such a way that the label (8′) is not placed over the graduated marks (4).

7) A disposable container comprising a transparent body (2) bearing graduated marks (4) and having a label (8) wrapped around it, wherein the label (8) has a transparent portion (9) placed over the graduated marks (4).

8) A disposable syringe comprising a transparent body (2) containing a medicine, and a plunger (3) slidably connected to the body (2) in a sealed fashion for dispensing the medicine, the body (2) having graduated marks (4) and having a label (8; 8″) describing the medicine wrapped around it, wherein the syringe (1) label (8; 8″) has a transparent portion (9) placed over the graduated marks (4).

9) The syringe according to claim 8, wherein the transparent portion (9) is a longitudinal band of the label (8, 8″).

10) The syringe according to claim 9, wherein the longitudinal band is substantially rectangular.

11) The syringe according to claim 8, wherein the label (8) is wrapped around the syringe (1) body (2) through 360°.

12) A labeling machine for implementing the method according to claim 1.
